(19) United States
(12) Patent Application Publication
(10) Pub. No.: US 2010/0201310 A1
(43) Pub. Date: Aug. 12, 2010

(54) WIRELESS POWER TRANSFER SYSTEM

(75) Inventors: Pieter Vorenkamp, Laguna Niguel, CA (US); Reinier Van Der Lee, Lake Forest, CA (US); InSun Van Loo, Wijchen (NL); Adam C. Spice, Trabuco Canyon, CA (US)

Correspondence Address: FIALA & WEAVER, P.L.L.C.;C/O CPA GLOBAL, P.O. BOX 52050, MINNEAPOLIS, MN, 55402, US

(73) Assignee: BROADCOM CORPORATION, Irvine, CA (US)

(21) Appl. No.: 12/421,762

(22) Filed: Apr. 10, 2009

Related U.S. Application Data
(60) Provisional application No. 61/150,554, filed on Feb. 6, 2009.

(51) Int. Cl. H02J 7/00; G06Q 30/00; H04B 5/00

(52) U.S. Cl. 320/108; 705/412; 705/34; 455/41.1

(57) ABSTRACT

A wireless power transfer system is described that includes features that allow the system to be deployed in public spaces such as airports or in commercial establishments such as restaurants or hotels to allow a user to recharge one or more portable electronic devices while away from home. In one embodiment, the system provides a secure and efficient means for obtaining required payment information from the user prior to the wireless power transfer, thereby facilitating fee-based recharging. In a further embodiment, to accommodate wireless recharging of a variety of device types and states, the system receives parameters and/or state information associated with a portable electronic device to be recharged and controls the wireless power transfer in accordance with such parameters and/or state information.

### CROSS-REFERENCE TO RELATED APPLICATIONS

This application claims priority to U.S. Provisional Patent Application No. 61/150,554, filed Feb. 6, 2009, the entirety of which is incorporated by reference herein.

### BACKGROUND OF THE INVENTION

1. Field of the Invention

The invention generally relates to systems capable of transmitting electrical power without wires.

2. Background

As used herein, the term wireless power transfer refers to a process by which electrical energy is transmitted from a power source to an electrical load without interconnecting wires. Wireless power transfer is useful for applications in which instantaneous or continuous energy transfer is needed, but for which providing a wired connection is inconvenient, hazardous, or impossible.

It has been observed that while electromagnetic radiation (such as radio waves) is excellent for transmitting information wirelessly, it is generally not suitable for transferring power wirelessly. For example, if power were transferred using omnidirectional electromagnetic waves, a vast majority of the power would end up being wasted in free space. Directed electromagnetic radiation such as lasers might be used to transfer power between a power source and a device, but this is not very practical and could even be dangerous. Such an approach would also require an uninterrupted line of sight between the power source and the device, as well as a sophisticated tracking mechanism when the device is mobile.

For the foregoing reasons, conventional systems that transfer power wirelessly are typically based on the concept of electromagnetic induction rather than electromagnetic radiation. These systems include systems based on inductive coupling and so-called “resonant inductive coupling.”

Inductive coupling refers to the transfer of energy from one circuit component to another through a shared electromagnetic field. In inductive coupling, a current running in an emitting coil induces another current in a receiving coil. The two coils are in close proximity, but do not touch.

Inductive coupling has been used in a variety of systems, including but not limited to systems that wirelessly charge a battery in a portable electronic device. In such systems, the portable electronic device is placed in close proximity to a charging station. A first induction coil in the charging station is used to create an alternating electromagnetic field, and a second induction coil in the portable electronic device derives power from the electromagnetic field and converts it back into electrical current to charge the battery. Thus, in such systems, there is no need for direct electrical contact between the battery and the charging station.

Some examples of various different types of charging systems based on the principle of inductive coupling are described in U.S. Pat. No. 3,938,018 to Dahl, entitled “Induction Charging System,” U.S. Pat. No. 4,873,677 to Sakamoto et al., entitled “Charging Apparatus for an Electronic Device,” U.S. Pat. No. 5,952,814 to Van Lerberghe, entitled “Induction Charging Apparatus and an Electronic Device,” U.S. Pat. No. 5,959,433 to Rohde, entitled “Universal Inductive Battery Charger System,” and U.S. Pat. No. 7,042,196 to Ka-Lai et al., entitled “Contact-less Power Transfer,” each of which is incorporated by reference as if fully set forth herein. Examples of some conventional devices that include batteries that may be recharged via inductive coupling include the Braun Oral B Plak Control Power Toothbrush, the Panasonic Digital Cordless Phone Solution KX-PH15AL and the Panasonic multi-head men's shavers ES70/40 series.

Another example of a technology that supports the use of inductive coupling to wirelessly transfer power is called Near Field Communication (NFC). NFC is a short-range high frequency wireless communication technology that enables the exchange of data between devices over approximately a decimeter distance. NFC is an extension of the ISO/IEC 14443 proximity-card standard that combines the interface of a smartcard and a reader into a single device. An NFC device can communicate with both existing ISO/IEC 14443 smartcards and readers, as well as with other NFC devices, and is thereby compatible with existing contactless infrastructure already in use for public transportation and payment. The air interface for NFC is described in ISO/IEC 18092/ECMA-340: Near Field Communication Interface and Protocol-1 (NFCIP-1) and ISO/IEC 21481/ECMA-352: Near Field Communication Interface and Protocol-2 (NFCIP-2), which are incorporated by reference herein.

NFC devices communicate via magnetic field induction, wherein two loop antennas are located within each other's near field, effectively forming an air-core transformer. In a passive communication mode, an initiator device provides a carrier field and a target device answers by modulating the existing field. In this mode, the target device may draw its operating power from the initiator-provided electromagnetic field.

“Resonant inductive coupling” refers to a more recently-publicized type of inductive coupling that utilizes magnetically-coupled resonators for wirelessly transferring power. In a system that uses resonant inductive coupling, a first coil attached to a sending unit generates a non-radiative magnetic field oscillating at MHz frequencies. The non-radiative field mediates a power exchange with a second coil attached to a receiving unit, which is specially designed to resonate with the field. The resonant nature of the process facilitates a strong interaction between the sending unit and the receiving unit, while the interaction with the rest of the environment is weak. Power that is not picked up by the receiving unit remains bound to the vicinity of the sending unit, instead of being radiated into the environment and lost.

Resonant inductive coupling is said to enable relatively efficient wireless power transfer over distances that are a few times the size of the device to be powered, therefore exceeding the performance of systems based on non-resonant inductive coupling. An example of a wireless power transfer system based on resonant inductive coupling is described in U.S. Patent Application Publication No. 2007/0222542 to Joannopoulos et al., entitled “Wireless Non-radiative Energy Transfer,” which is incorporated by reference herein.

Given the explosive growth in the use of portable electronic devices such as laptop computers, cellular telephones and portable media devices, it is anticipated that there will be a strong demand for systems that facilitate the wireless recharging of power sources based on various types of near field inductive coupling such as those described above. Indeed, it may be deemed desirable to make such systems available in public spaces such as airports or in commercial establishments such as restaurants or hotels to allow users to recharge their portable electronic devices while away from home.

Such wireless transfer of power in public or commercial environments may be made available to users for a fee. However, in order to achieve this, the wireless power transfer system must provide a secure and efficient way of obtaining requisite payment information from a user prior to performing the wireless power transfer. Still further, to accommodate wireless recharging of a variety of device types and states, the desired system should be able to receive parameters and/or state information associated with a portable electronic device to be recharged and to control the wireless power transfer in accordance with such parameters and/or state information.

Unfortunately, none of the foregoing systems based on inductive coupling or resonant inductive coupling provide such features. For example, although NFC devices may use magnetic field induction to wirelessly transfer power as well as payment information and other types of data, it does not appear that such NFC devices are designed to use the wirelessly transferred power to recharge a power source associated with a portable electronic device. Furthermore, it does not appear that such devices control the wireless power transfer based on parameters and/or state information received from the portable electronic device having a power source to be recharged.

### BRIEF SUMMARY OF THE INVENTION

As will be described in detail herein, a wireless power transfer system in accordance with an embodiment of the present invention includes features that allow the system to be deployed in public spaces such as airports or in commercial establishments such as restaurants or hotels to allow a user to recharge one or more portable electronic devices while away from home. In one embodiment, the system provides a secure and efficient means for obtaining required payment information from the user prior to the wireless power transfer, thereby facilitating fee-based recharging. In a further embodiment, to accommodate wireless recharging of a variety of device types and states, the system receives parameters and/or state information associated with a portable electronic device to be recharged and controls the wireless power transfer in accordance with such parameters and/or state information.

In particular, a method for wirelessly transferring power from a charging station to a portable electronic device is described herein. In accordance with the method, a wireless communication link is established with the portable electronic device. Payment information is then received from the portable electronic device via the wireless communication link. Responsive to receiving the payment information, power is transferred to the portable electronic device over a wireless power link.

In accordance with the foregoing method, the wireless communication link may be established in accordance with one of a Near Field Communication (NFC) protocol, a Bluetooth™ protocol, a ZigBee® protocol, or an IEEE 802.11 protocol.

The foregoing method may further include establishing the wireless power link. The wireless power link may be established based on inductive coupling or on resonant inductive coupling. The wireless communication link and the wireless power link may also be established via the same inductive link. The foregoing method may further include monitoring an amount of power wirelessly transferred to the portable electronic device and charging a user of the portable electronic device based on the monitored amount.

A charging station is also described herein. The charging station includes a transceiver, a communication link manager connected to the transceiver, and a power link manager connected to the communication link manager and the transceiver. The communication link manager is configured to establish a wireless communication link with a portable electronic device via the transceiver and to receive payment information from the portable electronic device via the wireless communication link. The power link manager is configured to establish a wireless power link with the portable electronic device via the transceiver and to transfer power to the portable electronic device over the wireless power link responsive to receipt of the payment information by the communication link manager.

An additional method for wirelessly transferring power from a charging station to a portable electronic device is described herein. In accordance with the method, a wireless communication link is established with the portable electronic device. Parameters and/or state information are then received from the portable electronic device via the wireless communication link. Power is then transferred to the portable electronic device over a wireless power link, wherein the manner in which power is transferred is controlled in accordance with the parameters and/or state information.

In accordance with the foregoing method, the parameters and/or state information may include a maximum safe power that may be received by the portable electronic device. The parameters and/or state information may also include an amount of power currently consumed or needed by the portable electronic device.

A further charging station is also described herein. The charging station includes a transceiver, a communication link manager connected to the transceiver and a power link manager connected to the communication link manager and the transceiver. The communication link manager is configured to establish a wireless communication link with a portable electronic device via the transceiver and to receive parameters and/or state information from the portable electronic device via the wireless communication link. The power link manager is configured to establish a wireless power link with the portable electronic device via the transceiver and to transfer power to the portable electronic device over the wireless power link, wherein the manner in which power is transferred is controlled in accordance with the parameters and/or state information.

A method for wirelessly receiving power from a charging station by a portable electronic device is also described herein. In accordance with the method, a wireless communication link is established with the charging station. Payment information is then transmitted to the charging station via the wireless communication link. Responsive to the receipt of the payment information by the charging station, power is received from the charging station over a wireless power link.

A portable electronic device is also described herein. The portable electronic device includes a transceiver, a communication link manager connected to the transceiver, and a battery recharging unit connected to the transceiver. The communication link manager is configured to establish a wireless communication link with a charging station via the transceiver and to transmit payment information to the charging station via the wireless communication link. The battery recharging unit is configured to establish a wireless power link with the charging station via the transceiver and to receive power from the charging station over the wireless power link responsive to receipt of the payment information by the charging station.

An additional method for wirelessly receiving power from a charging station by a portable electronic device is also described herein. In accordance with the method, a wireless communication link is established with the charging station. Parameters and/or state information are then transmitted to the charging station via the wireless communication link. Power is then received from the charging station over a wireless power link, wherein the manner in which power is transferred from the charging station is controlled in accordance with the parameters and/or state information. The foregoing method may further include monitoring the wireless power link to determine an amount of power transferred over the link and using the determined amount to generate the state information.

A further portable electronic device is described herein. The portable electronic device includes a transceiver, a communication link manager connected to the transceiver, and a battery recharging unit connected to the transceiver. The communication link manager is configured to establish a wireless communication link with a charging station via the communication link transceiver and to transmit parameters and/or state information to the charging station via the wireless communication link. The battery recharging unit is configured to establish a wireless power link with the charging station via the transceiver and to receive power from the charging station over the wireless power link, wherein the manner in which power is transferred from the charging station is controlled in accordance with the parameters and/or state information.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an example wireless power transfer system in accordance with an embodiment of the present invention.

FIG. 2 depicts a flowchart of a method for wirelessly transferring power from a charging station to a portable electronic device in accordance with an embodiment of the present invention.

FIG. 3 depicts a flowchart of a method for wirelessly receiving power from a charging station by a portable electronic device in accordance with an embodiment of the present invention.

FIG. 4 depicts a flowchart of an additional method for wirelessly transferring power from a charging station to a portable electronic device in accordance with an embodiment of the present invention.

FIG. 5 depicts a flowchart of an additional method for wirelessly receiving power from a charging station by a portable electronic device in accordance with an embodiment of the present invention.

FIG. 6 is a block diagram of a wireless power transfer system in accordance with an embodiment of the present invention in which a wireless power link is established using a receiver and transmitter and a wireless communication link is established using a separate pair of transceivers.

FIG. 7 is a block diagram of a wireless power transfer system in accordance with an alternate embodiment of the present invention in which a wireless communication link between a portable electronic device and a charging station is unidirectional.

FIG. 8 is a block diagram of a wireless power transfer system in accordance with an alternate embodiment of the present invention in which a charging station includes a plurality of different communication link transceivers to facilitate the establishment of wireless communication links with a plurality of different types of portable electronic devices.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Example Wireless Power Transfer System in Accordancer with an Embodiment of the Present Invention

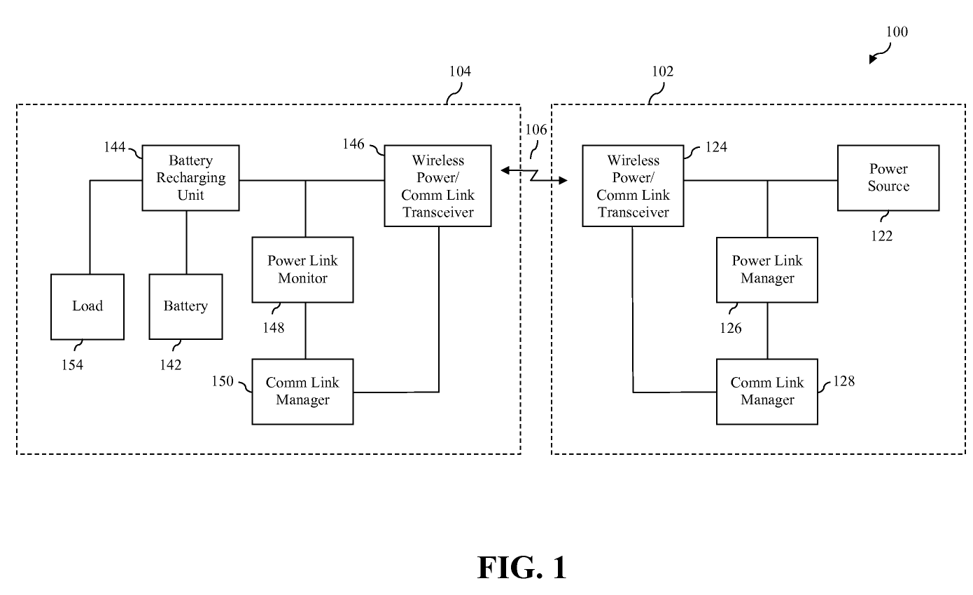

FIG. 1 is a block diagram of an example wireless power transfer system 100 in accordance with an embodiment of the present invention. System 100 includes a charging station 102 and a portable electronic device 104. As will be described in more detail herein, charging station 102 is configured to wirelessly transfer power to portable electronic device 104 responsive to receipt of payment information there from. Charging station 102 is also configured to manage the wireless transfer of power to portable electronic device 104 based on certain parameters and/or state information received from portable electronic device 104.

As shown in FIG. 1, charging station 102 includes a power source 122 connected to a wireless power/communication link transceiver 124. Wireless power/communication link transceiver 124 is configured to wirelessly transfer power supplied by power source 122 to a wireless power/communication link transceiver 146 associated with portable electronic device 104 via an inductive link 106. As will be appreciated by persons skilled in the relevant art(s), such wireless power transfer may be carried out over inductive link 106 in accordance with the well-known principles of inductive coupling or resonant inductive coupling as discussed in the Background Section above. As will be further appreciated by persons skilled in the relevant art(s), the manner in which wireless power/communication link transceiver 124 and wireless power/communication link transceiver 146 are implemented will depend on the type of inductive coupling used. A variety of transceiver designs based on inductive coupling and resonant inductive coupling are available in the art and thus need not be described herein.

Charging station 102 also includes a power link manager 126 connected between power source 122 and wireless power/communication link transceiver 124. Power link manager 126 is configured to sense when wireless power/communication link transceiver 146 associated with portable electronic device 104 is inductively coupled to wireless power/communication link transceiver 124 and is thus capable of receiving power wirelessly there from. Power link manager 126 is further configured to transfer power wirelessly over inductive link 106 responsive to control signals from a communication link manager 128. Power link manager 126 may be further configured to monitor the amount of power that is wirelessly transferred via inductive link 106 to portable electronic device 104.

Communication link manager 128 is connected both to power link manager 126 and to wireless power/communication link transceiver 124. Communication link manager 128 is configured to establish and maintain a wireless communication link with portable electronic device 104 via wireless power/communication link transceiver 124 for the purpose of obtaining payment information and other information there from. Such other information may include, for example, device-specific parameters associated with portable electronic device 104 such as a maximum safe power that may be transferred to portable electronic device 104. Such other information may also include, for example, state information associated with portable electronic device 104 such an amount of power currently consumed or needed by portable electronic device 104.

Communication link manager 128 is thus configured to use inductive link 106 for the wireless communication of data. Depending upon the implementation, communication link manager 128 may be configured to carry out the wireless communication of data in accordance with any standard or proprietary induction-based data communication protocol. For example, communication link manager 128 may be configured to carry out the wireless communication of data in accordance with an NFC protocol as described in the Background Section above, although this example is not intended to be limiting and other standard or proprietary induction-based data communication protocols may be used.

Communication link manager 128 is further configured to transmit control signals to power link manager 126 to control whether and when power link manager 126 may transfer power wirelessly to portable electronic device 104. Communication link manager 128 can thus ensure that power is transferred to portable electronic device 104 only after requisite payment information has been received from portable electronic device 104. Communication link manager 128 can also control power link manager 126 to ensure that power is delivered to portable electronic device 104 in a manner that takes into account certain device-specific parameters such as a maximum safe power that may be transferred to portable electronic device 104 or state information such as an amount of power currently consumed or needed by portable electronic device 104.

Portable electronic device 104 within power transfer system 100 will now be described. As shown in FIG. 1, portable electronic device 104 includes a battery recharging unit 144 connected to wireless power/communication link transceiver 146. Wireless power/communication link transceiver 146 is configured to transfer wireless power received over inductive link 106 to battery recharging unit 144, which is configured to use such power to recharge a battery 142 connected thereto. Battery recharging unit 144 is also connected to a load 154 associated with portable electronic device 104, which can be powered by battery 142 in a well-known manner.

Portable electronic device 104 further includes a power link monitor 148 connected between wireless power/communication link transceiver 146 and battery recharging unit 144. Power link monitor 148 may be configured to monitor an amount of power that is wirelessly received via inductive link 106 and to provide this information to a communication link manager 150. Power link monitor 148 may provide other state information to communication link manager 150 including, for example, a current state of battery 142.

Communication link manager 150 is connected both to power link monitor 148 and to wireless power/communication link transceiver 146. Communication link manager 150 is configured to establish and maintain a wireless communication link with charging station 102 via wireless power/communication link transceiver 146 for the purpose of providing payment information and other information thereto. As noted above, such other information may include, for example, device-specific parameters associated with portable electronic device 104, such as a maximum safe power that may be transferred to portable electronic device 104, or state information associated with portable electronic device 104 such an amount of power currently consumed or needed by portable electronic device 104. This state information may be based on or derived from state information provided by power link monitor 148.

Communication link manager 150 is thus configured to use inductive link 106 for the wireless communication of data. Depending upon the implementation, communication link manager 150 may be configured to carry out the wireless communication of data in accordance with any standard or proprietary induction-based data communication protocol. For example, communication link manager 150 may be configured to carry out the wireless communication of data in accordance with an NFC protocol as described in the Background Section above, although this example is not intended to be limiting and other standard or proprietary induction-based data communication protocols may be used.

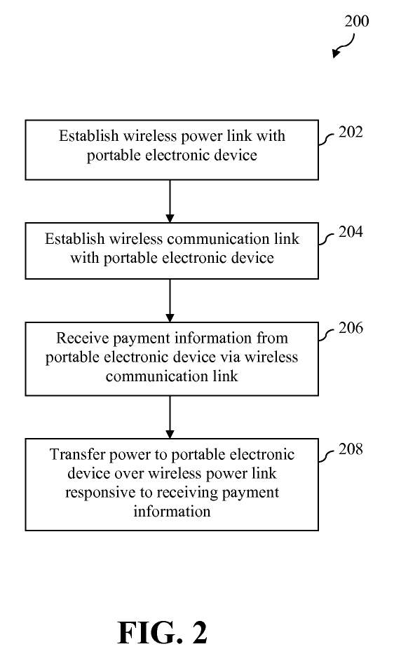

FIG. 2 depicts a flowchart 200 of a method for wirelessly transferring power from a charging station to a portable electronic device in accordance with an embodiment of the present invention. The method of flowchart 200 will now be described in reference to certain elements of example wireless transfer system 100 as described above in reference to FIG. 1. However, the method is not limited to that implementation.

As shown in FIG. 2, the method of flowchart 200 begins at step 202 in which power link manager 126 of charging station 102 establishes a wireless power link with portable electronic device 104. Power link manager 126 performs this function by allowing power to flow from power source 122 to wireless power/communication link transceiver 124, which has the effect of creating inductive link 106 between wireless power/communication link transceiver 124 of charging station 102 and wireless power/communication link transceiver 146 of portable electronic device 104. As discussed above, depending upon the implementation of wireless power/communication link transceiver 124 and wireless power/communication link transceiver 146, inductive link 106 may be created for example based on the principles of inductive coupling or resonant inductive coupling.

At step 204, communication link manager 128 of charging station 102 establishes a wireless communication link with portable electronic device 104. Communication link manager 128 performs this function by transmitting and/or receiving signals via wireless power/communication link transceiver 124 to/from wireless power/communication link transceiver 146 associated with portable electronic device 104. The wireless communication link is thus established via inductive link 106. As discussed above, the wireless communication link may be established in accordance with any standard or proprietary inductance-based data communication protocol.

At step 206, communication link manager 128 of charging station 102 receives payment information from portable electronic device 104 via the wireless communication link. As will be appreciated by persons skilled in the relevant art(s), the type of payment information that is received during step 206 may vary depending on the manner in which the wireless power transfer service is to be paid for by the user of portable electronic device 104.

For example, if the user will pay for the wireless power transfer through the subsequent billing of a credit card account, checking account, or some other account from which funds may be transferred, then the payment information may include a unique account identifier, such as an account number. Alternatively, if the charge to the user will be added to a list of additional charges due from the user (e.g., the charge is to be added to a hotel bill for the user), then the payment information may include a unique identifier of the user.

Furthermore, if the user has already paid for the wireless power transfer, then the payment information may include an electronic token indicating that such payment has occurred. Alternatively, if the user has purchased prepaid credits towards the wireless power transfer, then the payment information may include an electronic funds amount that is currently available to the user/owner for obtaining the service. The electronic funds amount may be stored on portable electronic device 104, or a card inserted or attached to portable electronic device 104.

The foregoing description of the types of payment information that may be received during step 206 are provided by way of example only and are not intended to limit the present invention. Persons skilled in the relevant art(s) will readily appreciate that other types of payment information may be received during step 206 other than or in addition to those types described above.

After the payment information has been received by communication link manager 128 during step 206, communication link manager 128 sends one or more control signals to power link manager 126 and, responsive to receiving the control signal(s), power link manager 126 allows power to be transferred to portable electronic device 104 over the wireless power link. This is generally shown at step 208.

In an embodiment, communication link manager 128 validates and/or processes the payment information prior to sending the control signal(s) to power link manager 126. In another embodiment, communication link manager 128 transmits the payment information to an external entity for validation and/or processing prior to sending the control signal(s) to power link manager 126. For example, communication link manager 128 may provide the payment information to a network interface within charging station 102 (not shown in FIG. 1) for wired or wireless communication to a network entity, such as a server, for processing and/or validation.

In a further implementation of the foregoing method, power link manager 126 monitors or meters the amount of power wirelessly transferred to portable electronic device 104 via the wireless power link. The monitored amount can then be used to charge the user of portable electronic device 104 based on the amount of power transferred. In one embodiment, the monitored amount is transmitted to an external entity so that the user of portable electronic device 104 may be charged based on the monitored amount. The external entity may be, for example, a remote network entity, such as a server, or may be portable electronic device 104.

In the foregoing method of flowchart 200, the establishment of the wireless power link in step 202 may occur before, contemporaneously with, or after the establishment of the wireless communication link in step 204 depending upon the implementation. Furthermore, the establishment of the wireless power link may occur responsive to the establishment of the wireless communication link or vice versa. With respect to the establishment of the wireless communication link, either charging station 102 or portable electronic device 104 may act as the initiator depending upon the implementation.

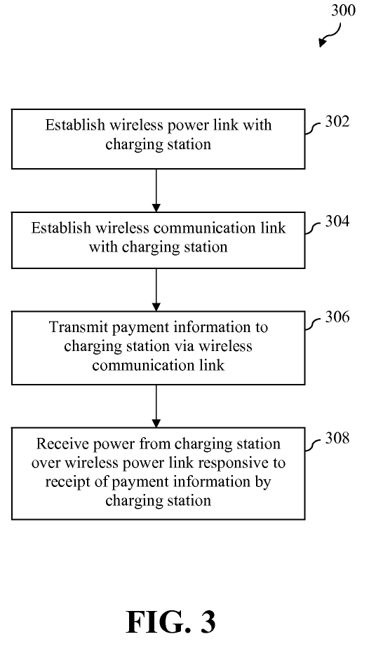

FIG. 3 depicts a flowchart 300 of a method for wirelessly receiving power from a charging station by a portable electronic device in accordance with an embodiment of the present invention. In contrast to the steps of flowchart 200, which are performed by a charging station, the steps of flowchart 300 are performed by a portable electronic device that is configured to interact with a charging station. Thus, the method of flowchart 300 may be thought of as a counterpart method to the method of flowchart 200.

The method of flowchart 300 will now be described in reference to certain elements of example wireless transfer system 100 as described above in reference to FIG. 1. However, the method is not limited to that implementation.

As shown in FIG. 3, the method of flowchart 300 begins at step 302 in which a wireless power link is established between wireless power/communication link transceiver 146 of portable electronic device 104 and wireless power/communication link transceiver 124 of charging station 102. The manner in which such a wireless power link is established was discussed above in reference to step 202 of flowchart 200.

At step 304, communication link manager 150 of portable electronic device 104 establishes a wireless communication link with charging station 102. Communication link manager 150 performs this function by transmitting and/or receiving signals via wireless power/communication link transceiver 146 to/from wireless power/communication link transceiver 124 associated with charging station 102. The wireless communication link is thus established via inductive link 106. As discussed above, the wireless communication link may be established in accordance with any standard or proprietary inductance-based data communication protocol.

At step 306, communication link manager 150 of portable electronic device 104 transmits payment information to charging station 102 via the wireless communication link. As will be appreciated by persons skilled in the relevant art(s), the type of payment information that is transmitted during step 306 may vary depending on the manner in which the wireless power transfer service is to be paid for by the user of portable electronic device 104. Examples of various types of payment information were described above in reference to step 206 of flowchart 200.

Responsive to the receipt of the payment information by charging station 102, charging station 102 transfers power to portable electronic device 104 over the wireless power link. The transferred power is received by wireless power/communication link transceiver 146 and applied to battery recharging unit 144. This is generally shown at step 308.

In the foregoing method of flowchart 300, the establishment of the wireless power link in step 302 may occur before, contemporaneously with, or after the establishment of the wireless communication link in step 304 depending upon the implementation. Furthermore, the establishment of the wireless power link may occur responsive to the establishment of the wireless communication link or vice versa. With respect to the establishment of the wireless communication link, either charging station 102 or portable electronic device 104 may act as the initiator depending upon the implementation.

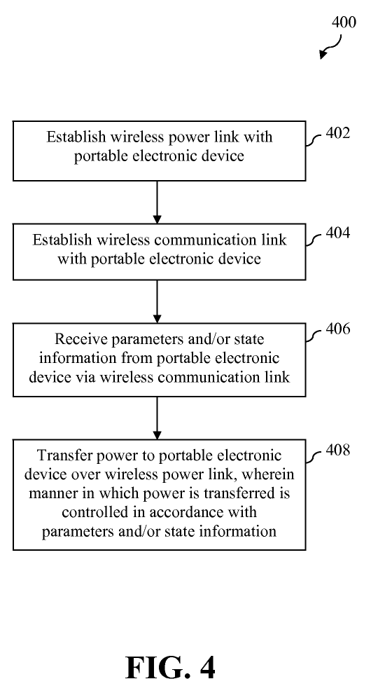

FIG. 4 depicts a flowchart 400 of an additional method for wirelessly transferring power from a charging station to a portable electronic device in accordance with an embodiment of the present invention. The method of flowchart 400 will now be described in reference to certain elements of example wireless transfer system 100 as described above in reference to FIG. 1. However, the method is not limited to that implementation.

As shown in FIG. 4, the method of flowchart 400 begins at step 402 in which power link manager 126 of charging station 102 establishes a wireless power link with portable electronic device 104. Power link manager 126 performs this function by allowing power to flow from power source 122 to wireless power/communication link transceiver 124, which has the effect of creating inductive link 106 between wireless power/communication link transceiver 124 of charging station 102 and wireless power/communication link transceiver 146 of portable electronic device 104. As discussed above, depending upon the implementation of wireless power/communication link transceiver 124 and wireless power/communication link transceiver 146, inductive link 106 may be created based on the principles of inductive coupling or resonant inductive coupling for example.

At step 404, communication link manager 128 of charging station 102 establishes a wireless communication link with portable electronic device 104. Communication link manager 128 performs this function by transmitting and/or receiving signals via wireless power/communication link transceiver 124 to/from wireless power/communication link transceiver 146 associated with portable electronic device 104. The wireless communication link is thus established via inductive link 106. As discussed above, the wireless communication link may be established in accordance with any standard or proprietary inductance-based data communication protocol.

At step 406, communication link manager 128 of charging station 102 receives parameters and/or state information from portable electronic device 104 via the wireless communication link. The parameters may include, for example, a maximum safe power that may be transmitted to portable electronic device 104. The state information may include, for example, an amount of power currently consumed or needed by portable electronic device 104.

After receiving the parameters and/or state information, communication link manager 128 sends one or more control signals to power link manager 126 and, responsive to receiving the control signal(s), power link manager 128 transfers power to portable electronic device 104 over the wireless power link in a manner that takes into account the received parameters and/or state information. This is generally shown at step 408.

In one embodiment, controlling the power transfer in accordance with received parameters includes controlling the wireless power link to ensure that the amount of power transferred over the link does not exceed a maximum safe power that may be transmitted to portable electronic device 104. In another embodiment, controlling the power transfer in accordance with received state information includes controlling the wireless power link to ensure that the amount of power that is transferred over the link is sufficient to recharge portable electronic device 104 or does not exceed an amount of power that is sufficient to recharge portable electronic device 104.

In the foregoing method of flowchart 400, the establishment of the wireless power link in step 402 may occur before, contemporaneously with, or after the establishment of the wireless communication link in step 404 depending upon the implementation. Furthermore, the establishment of the wireless power link may occur responsive to the establishment of the wireless communication link or vice versa. With respect to the establishment of the wireless communication link, either charging station 102 or portable electronic device 104 may act as the initiator depending upon the implementation.

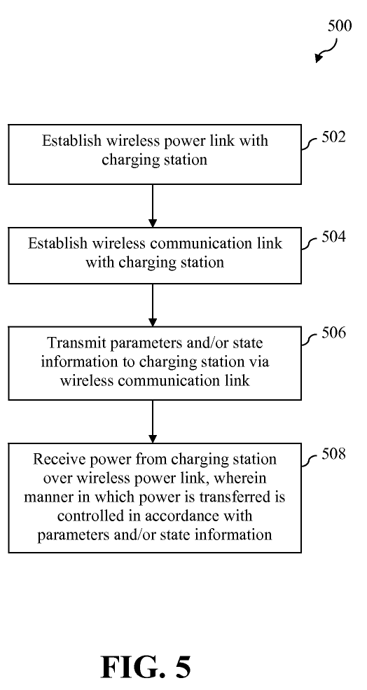

FIG. 5 depicts a flowchart 500 of a method for wirelessly receiving power from a charging station by a portable electronic device in accordance with an embodiment of the present invention. In contrast to the steps of flowchart 400, which are performed by a charging station, the steps of flowchart 500 are performed by a portable electronic device that is configured to interact with a charging station. Thus, the method of flowchart 500 may be thought of as a counterpart method to the method of flowchart 400.

The method of flowchart 500 will now be described in reference to certain elements of example wireless transfer system 100 as described above in reference to FIG. 1. However, the method is not limited to that implementation.

As shown in FIG. 5, the method of flowchart 500 begins at step 502 in which a wireless power link is established between wireless power/communication link transceiver 146 of portable electronic device 104 and wireless power/communication link transceiver 124 of charging station 102. The manner in which such a wireless power link is established was discussed above in reference to step 402 of flowchart 400.

At step 504, communication link manager 150 of portable electronic device 104 establishes a wireless communication link with charging station 102. Communication link manager 150 performs this function by transmitting and/or receiving signals via wireless power/communication link transceiver 146 to/from wireless power/communication link transceiver 124 associated with charging station 102. The wireless communication link is thus established via inductive link 106. As discussed above, the wireless communication link may be established in accordance with any standard or proprietary inductance-based data communication protocol.

At step 506, communication link manager 150 of portable electronic device 104 transmits parameters and/or state information to charging station 102 via the wireless communication link. As noted above, the parameters may include, for example, a maximum safe power that may be transmitted to portable electronic device 104 and the state information may include, for example, an amount of power currently consumed or needed by portable electronic device 104.

In an embodiment, communication link manager 150 generates or derives the state information from information collected by power link monitor 148. For example, power link monitor 148 may monitor the wireless power link to determine an amount of power transferred over the link. This amount of power may then be reported as state information to charging station 102 over the wireless communication link. Additionally, power link monitor 148 may provide other state information to communication link manager 150 including, for example, a current state of battery 142.

Responsive to the receipt of the parameters and/or state information by charging station 102, charging station 102 transfers power to portable electronic device 104 over the wireless power link, wherein the manner in which power is transferred is controlled in accordance with the parameters and/or state information. The transferred power is received by wireless power/communication link transceiver 146 and applied to battery recharging unit 144. This is generally shown at step 508.

In the foregoing method of flowchart 500, the establishment of the wireless power link in step 502 may occur before, contemporaneously with, or after the establishment of the wireless communication link in step 504 depending upon the implementation. Furthermore, the establishment of the wireless power link may occur responsive to the establishment of the wireless communication link or vice versa. With respect to the establishment of the wireless communication link, either charging station 102 or portable electronic device 104 may act as the initiator depending upon the implementation.

### B. Alternative Wireless Power Transfer System Implementations

Alternative implementations of wireless power transfer system 100 will now be described. Each of the alternative implementations is also capable of wirelessly transferring/receiving power in accordance with the methods of flowcharts 200, 300, 400 and 500 as described above in reference to FIG. 2, FIG. 3, FIG. 4 and FIG. 5, respectively.

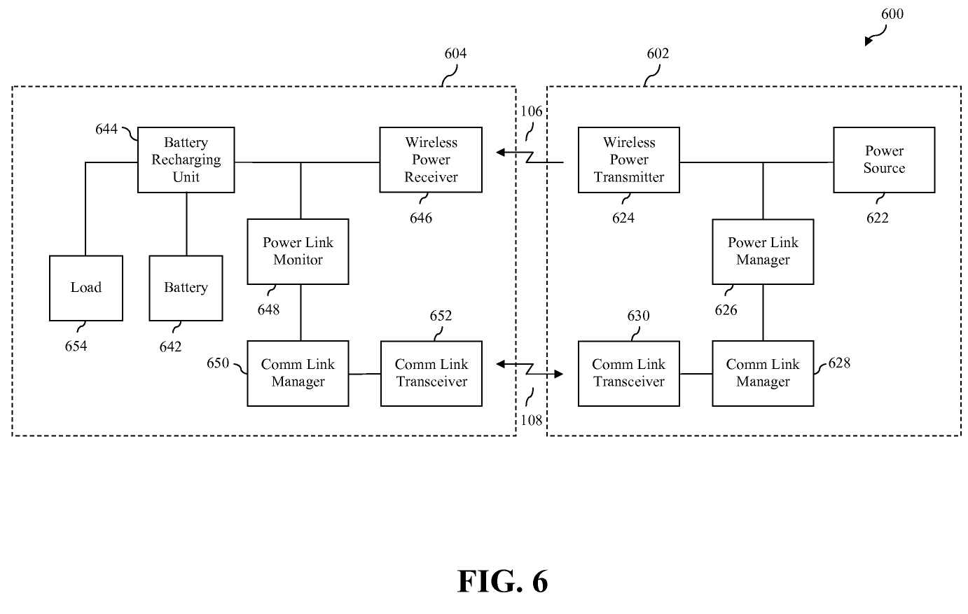

For example, FIG. 6 is a block diagram of a wireless power transfer system 600 that includes similar elements to those described in reference to FIG. 1 except that the wireless power link between the charging station and the portable electronic device is implemented using a wireless power transmitter and receiver while the wireless communication link between the charging station and the portable electronic device is implemented using a separate pair of communication link transceivers.

As shown in FIG. 6, wireless power transfer system 600 includes a charging station 602 and a portable electronic device 604. With the exception of certain elements discussed below, the elements of charging station 602 are configured to function in a similar manner to like-named elements of charging station 102 of FIG. 1. Likewise, with the exception of certain elements discussed below, the elements of portable electronic device 604 are configured to function in a similar manner to like-named elements of portable electronic device 104 of FIG. 1.

Charging station 602 includes a wireless power transmitter 624 and portable electronic device 604 includes a wireless power receiver 646. Wireless power transmitter 624 is configured to operate under the control of power link manager 626 to wirelessly transfer power supplied by power source 622 to wireless power receiver 646 associated with portable electronic device 604 via an inductive link 606. The wireless power transfer may be carried out over inductive link 606 in accordance with the well-known principles of inductive coupling or resonant inductive coupling as discussed in the Background Section above. The manner in which wireless power transmitter 624 and wireless power receiver 646 are implemented will depend on the type of inductive coupling used. A variety of transmitter and receiver designs based on inductive coupling and resonant inductive coupling are available in the art and thus need not be described herein.

Charging station 602 further includes a communication link transceiver 630 and portable electronic device 604 further includes a communication link transceiver 652. In the embodiment shown in FIG. 6, communication link transceivers 630 and 652 are used to establish and maintain a wireless communication link 608 between charging station 602 and portable electronic device 604 that is separate from inductive link 606. Wireless communication link 608 is established for the purpose of transferring payment information and/or device-specific parameters or state information from portable electronic device 604 to charging station 602. Charging station 602 may then use such information in a like manner to that described above with respect to charging station 102 of FIG. 1.

As will be appreciated by persons skilled in the relevant art(s), the manner in which communication link transceivers 630 and 652 are implemented will depend on the type of wireless communication link to be established there between. In accordance with one embodiment of the present invention, wireless communication link 608 may be established using NFC technology as described above in the Background Section. Alternatively, wireless communication link 608 may be established in accordance with certain RF-based short-range communication technologies such as Bluetooth™, as described in the various standards developed and licensed by the Bluetooth™ Special Interest Group, or technologies such as ZigBee® that are based on the IEEE 802.15.4 standard for wireless personal area networks (specifications describing ZigBee are publically available from the ZigBee® Alliance). Still further, wireless communication link 608 may be established in accordance with other RF-based communication technologies such as any of the well-known IEEE 802.11 protocols. However, these examples are not intended to be limiting and wireless communication link 608 between charging station 602 and portable electronic device 604 may be established using a variety of other standard or propriety communication protocols.

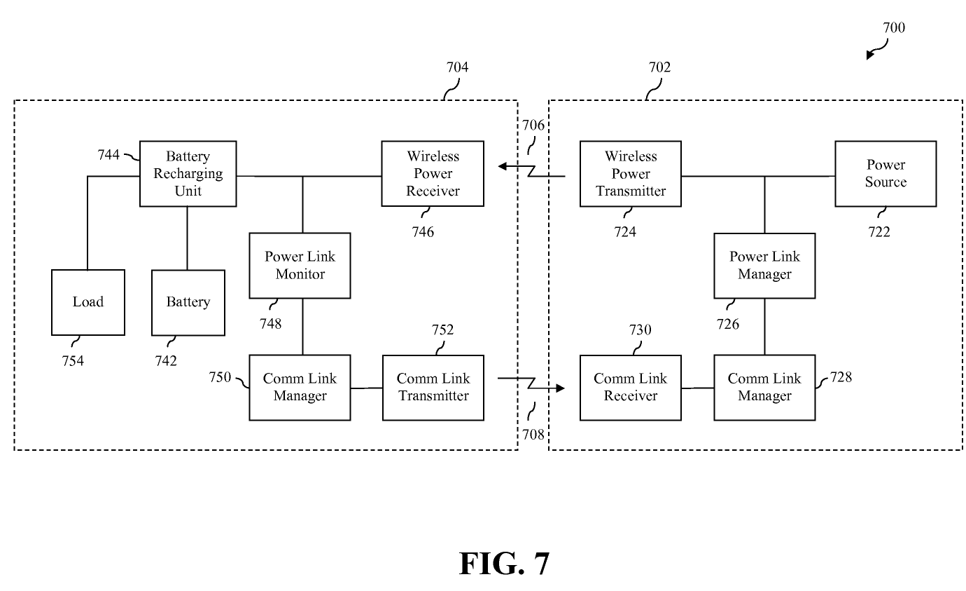

FIG. 7 is a block diagram of a wireless power transfer system 700 that includes similar elements to those described in reference to FIG. 6 except that the wireless communication link between the portable electronic device and the charging station is unidirectional rather than bidirectional.

As shown in FIG. 7, wireless power transfer system 700 includes a charging station 702 and a portable electronic device 704. With the exception of certain elements discussed below, the elements of charging station 702 are configured to function in a similar manner to like-named elements of charging station 602 of FIG. 6. Likewise, with the exception of certain elements discussed below, the elements of portable electronic device 704 are configured to function in a similar manner to like-named elements of portable electronic device 604 of FIG. 6.

As further shown in FIG. 7, portable electronic device 704 includes a communication link transmitter 752 and charging station 702 includes a communication link receiver 730. Communication link manager 750 within portable electronic device 704 is configured to establish a unidirectional wireless communication link 708 with charging station 702 by transmitting signals via communication link transmitter 752 to communication link receiver 730. This unidirectional wireless communication link may then be used to transmit payment information and/or device-specific parameters or state information from portable electronic device 704 to charging station 702. Charging station 702 may then use such information in a like manner to that described above with respect to charging station 102 of FIG. 1.

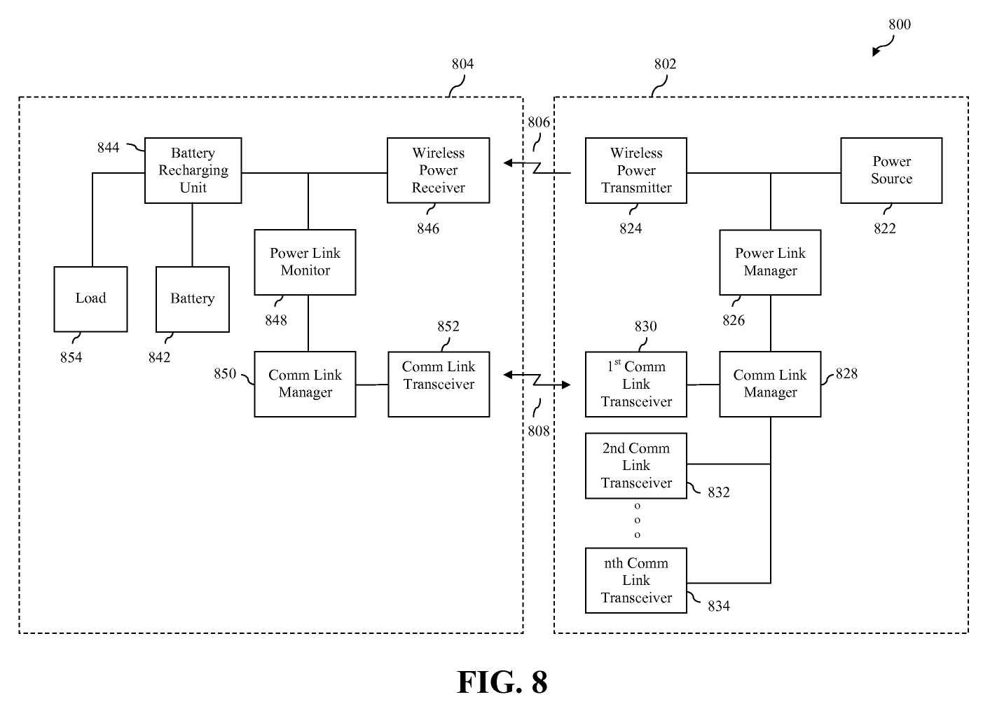

FIG. 8 is a block diagram of a wireless power transfer system 800 that includes similar elements to those described in reference to FIG. 6 except that the charging station includes a plurality of different communication link transceivers to facilitate the establishment of wireless communication links with a plurality of different types of portable electronic devices.

As shown in FIG. 8, wireless power transfer system 800 includes a charging station 802 and a portable electronic device 804. With the exception of certain elements discussed below, the elements of charging station 802 are configured to function in a similar manner to like-named elements of charging station 602 of FIG. 6. Likewise, with the exception of certain elements discussed below, the elements of portable electronic device 804 are configured to function in a similar manner to like-named elements of portable electronic device 604 of FIG. 6.

As further shown in FIG. 8, charging station 802 includes a plurality of communication link transceivers connected to communication link manager 828. The plurality of communication link transceivers includes a first communication link transceiver 830, a second communication link transceiver 832, and so on, up to an n^{th} communication link transceiver 834. Each of the communication link transceivers is configured for wireless communication in accordance with a different wireless protocol. For example, first communication link transceiver 830 may be configured for communication in accordance with NFC, second communication link transceiver 832 may be configured for communication in accordance with Bluetooth™, and n^{th} communication link transceiver 834 may be configured for communication in accordance with one of the IEEE 802.11 standards. This advantageously enables charging station 802 to receive payment information and device-specific parameters and/or state information from a plurality of different device types to facilitate the wireless transfer of power to such devices.

### C. Conclusion

While various embodiments of the present invention have been described above, it should be understood that they have been presented by way of example only, and not limitation. It will be understood by those skilled in the relevant art(s) that various changes in form and details may be made to the embodiments of the present invention described herein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for wirelessly transferring power from a charging station to a portable electronic device, comprising:
establishing a wireless communication link with the portable electronic device;
receiving payment information from the portable electronic device via the wireless communication link; and
transferring power to the portable electronic device over a wireless power link responsive to receiving the payment information.

2. The method of claim 1, wherein establishing a wireless communication link with the portable electronic device comprises establishing a communication link in accordance with one of:
a Near Field Communication (NFC) protocol;
a Bluetooth™ protocol;
a ZigBee® protocol; or
an IEEE 802.11 protocol.

3. The method of claim 1, wherein receiving payment information from the portable electronic device comprises receiving one or more of:
a user identifier;
an account identifier;
an electronic funds amount; or
a token.

4. The method of claim 1, further comprising:
establishing the wireless power link.

5. The method of claim 4, wherein establishing the wireless power link comprises establishing the wireless power link based on inductive coupling.

6. The method of claim 4, wherein establishing the wireless power link comprises establishing the wireless power link based on resonant inductive coupling.

7. The method of claim 4, wherein the wireless communication link and the wireless power link are established via the same inductive link.

8. The method of claim 1, further comprising:
monitoring an amount of power wirelessly transferred to the portable electronic device; and
charging a user of the portable electronic device based on the monitored amount.

9. A charging station comprising:
a transceiver;
a communication link manager connected to the transceiver, the communication link manager configured to establish a wireless communication link with a portable electronic device via the transceiver and to receive payment information from the portable electronic device via the wireless communication link; and
a power link manager connected to the communication link manager and the transceiver, the power link manager configured to establish a wireless power link with the portable electronic device via the transceiver and to transfer power to the portable electronic device over the wireless power link responsive to receipt of the payment information by the communication link manager.

10. The charging station of claim 9, wherein the payment information comprises one or more of:
a user identifier;
an account identifier;
an electronic funds amount; or
a token.

11. The charging station of claim 9, wherein the power link manager is configured to establish the wireless power link based on inductive coupling.

12. The charging station of claim 9, wherein the power link manager is configured to establish the wireless power link based on resonant inductive coupling.

13. The charging station of claim 9, wherein the power link manager is further configured to monitor an amount of power wirelessly transferred to the portable electronic device and the communication link manager is configured to transmit the monitored amount to an external entity so that a user of the portable electronic device may be charged based on the monitored amount.

14. A method for wirelessly transferring power from a charging station to a portable electronic device, comprising:
establishing a wireless communication link with the portable electronic device;
receiving parameters and/or state information from the portable electronic device via the wireless communication link; and
transferring power to the portable electronic device over a wireless power link, wherein the manner in which power is transferred is controlled in accordance with the parameters and/or state information.

15. The method of claim 14, wherein establishing a wireless communication link with the portable electronic device comprises establishing a communication link in accordance with one of:
a Near Field Communication (NFC) protocol;
a Bluetooth™ protocol;
a ZigBee® protocol; or
an IEEE 802.11 protocol.

16. The method of claim 14, wherein the parameters and/or state information comprises a maximum safe power that may be received by the portable electronic device.

17. The method of claim 14, wherein the parameters and/or state information comprises an amount of power currently consumed or needed by the portable electronic device.

18. The method of claim 14, further comprising:
establishing the wireless power link.

19. The method of claim 18, wherein establishing the wireless power link comprises establishing the wireless power link based on inductive coupling.

20. The method of claim 18, wherein establishing the wireless power link comprises establishing the wireless power link based on resonant inductive coupling.

21. The method of claim 18, wherein the wireless communication link and the wireless power link are established via the same inductive link.

22. A charging station comprising:
a transceiver;
a communication link manager connected to the transceiver, the communication link manager configured to establish a wireless communication link with a portable electronic device via the transceiver and to receive parameters and/or state information from the portable electronic device via the wireless communication link; and
a power link manager connected to the communication link manager and the transceiver, the power link manager configured to establish a wireless power link with the portable electronic device via the transceiver and to transfer power to the portable electronic device over the wireless power link, wherein the manner in which power is transferred is controlled in accordance with the parameters and/or state information.

23. The charging station of claim 22, wherein the parameters and/or state information comprises a maximum safe power that may be received by the portable electronic device.

24. The charging station of claim 22, wherein the parameters and/or state information comprises an amount of power currently consumed or needed by the portable electronic device.

25. The charging station of claim 22, wherein the power link manager is configured to establish the wireless power link based on inductive coupling.

26. The charging station of claim 22, wherein the power link manager is configured to establish the wireless power link based on resonant inductive coupling.

27. A method for wirelessly receiving power from a charging station by a portable electronic device, comprising:
establishing a wireless communication link with the charging station;
transmitting payment information to the charging station via the wireless communication link; and
receiving power from the charging station over a wireless power link responsive to receipt of the payment information by the charging station.

28. The method of claim 27, wherein the wireless communication link and the wireless power link are established over the same inductive link.

29. A portable electronic device, comprising:
a transceiver;
a communication link manager connected to the transceiver, the communication link manager configured to establish a wireless communication link with a charging station via the transceiver and to transmit payment information to the charging station via the wireless communication link; and
a battery recharging unit connected to the transceiver, the battery recharging unit configured to establish a wireless power link with the charging station via the transceiver and to receive power from the charging station over the wireless power link responsive to receipt of the payment information by the charging station.

30. A method for wirelessly receiving power from a charging station by a portable electronic device, comprising:
establishing a wireless communication link with the charging station;
transmitting parameters and/or state information to the charging station via the wireless communication link; and
receiving power from the charging station over a wireless power link, wherein the manner in which power is transferred from the charging station is controlled in accordance with the parameters and/or state information.

31. The method of claim 30, further comprising:
monitoring the wireless power link to determine an amount of power transferred over the link;
using the determined amount to generate the state information.

32. The method of claim 30, wherein the wireless communication link and the wireless power link are established over the same inductive link.

33. A portable electronic device comprising:
a transceiver;
a communication link manager connected to the transceiver, the communication link manager configured to establish a wireless communication link with a charging station via the transceiver and to transmit parameters and/or state information to the charging station via the wireless communication link; and
a battery recharging unit connected to the transceiver, the battery recharging unit configured to establish a wireless power link with the charging station via the transceiver and to receive power from the charging station over the wireless power link, wherein the manner in which power is transferred from the charging station is controlled in accordance with the parameters and/or state information.

34. The portable electronic device of claim 33, further comprising:
a power link monitor connected to the transceiver and the communication link manager, the power link monitor configured to monitor the wireless power link to determine an amount of power transferred over the link and to use the determined amount to generate the state information.
